(19) United States
(12) Patent Application Publication
(10) Pub. No.: US 2022/0416632 A1
(43) Pub. Date: Dec. 29, 2022

(54) ROTARY DRIVE DEVICE AND MANUFACTURING METHOD THEREOF

(71) Applicant: HONDA MOTOR CO., LTD., Tokyo (JP)

(72) Inventors: Hiroshi GOTOH, Tokyo (JP); Shintaro YOKOTA, Tokyo (JP); Takuya FUJIMORI, Tokyo (JP); Akihito KUBO, Tokyo (JP); Keita YANO, Tokyo (JP)

(21) Appl. No.: 17/844,907

(22) Filed: Jun. 21, 2022

(30) Foreign Application Priority Data
Jun. 23, 2021 (JP) 2021-104315

(51) Int. Cl. H02K 15/16; H02K 15/14

(52) U.S. Cl. CPC H02K 15/16; H02K 15/14

(57) ABSTRACT

A motor having a rotor connected to an input shaft and a stator fixed by a fixing jig during assembly to a case includes: a stator convex part that extends radially outward from an outer circumference of the stator and positions the stator with respect to the case; and a case convex part that extends radially inward from an inner circumference of the case and is arranged so as to overlap with the stator convex part in a circumferential direction. A relief part is provided between the stator convex part and the case convex part, the relief part being arranged such that the stator convex part can be rotated along the circumferential direction with respect to the case during assembly.

### CROSS-REFERENCE TO RELATED APPLICATION

This application is based upon and claims priority from the Japanese Patent Application No. 2021-104315, filed on Jun. 23, 2021, the entire contents of which are incorporated herein by reference.

### BACKGROUND OF THE INVENTION

### 1. Field of the Invention

The present invention relates to a rotary drive device such as a motor and a manufacturing method thereof.

### 2. Description of the Related Art

When assembling a stator and a rotor to a casing, magnetic attractive force acts between the stator and the rotor. There is a method in which the stator is attached to the casing in advance, and then the rotor is attached while securing a clearance with the stator by using a center guide, for example.

However, when the center guide cannot be used, a method is known as disclosed in Japanese Patent No. 6513240, for example, in which the stator and the rotor are fixed in advance by a jig and the jig is removed after assembling the stator and the rotor fixed by the jig to the casing.

### SUMMARY OF THE INVENTION

In a manufacturing method disclosed in Japanese Patent No. 6513240, when the stator and the rotor are assembled in a state of being fixed by the jig, the phase of the rotor depends on the phase of the stator. For this reason, it becomes difficult to match the phase of the rotor with that of a rotary driving force transmission member (for example, an input shaft or the like) arranged on the downstream side of the rotor, and the assemblability may be deteriorated.

The present invention has been made to solve the above problems and makes it an object thereof to provide a rotary drive device capable of easily performing phase matching between a rotor and an input shaft or the like, and a manufacturing method thereof.

In order to achieve the above object, the present invention provides a rotary drive device including a rotor member connected to a rotary driving force transmission member, a stator mounted on the radially outer side of the rotor member, and a case that has the rotary driving force transmission member and has the rotor member and the stator assembled therein, and in which the rotor member and the stator are fixed to each other by a fixing jig during assembly to the case. The rotary drive device includes a stator convex part that extends radially outward from the outer circumference of the stator and positions the stator with respect to the case, and a case convex part that extends radially inward from the inner circumference of the case and is arranged so as to overlap with the stator convex part in the circumferential direction. A relief part is provided between the stator convex part and the case convex part so as to allow the stator convex part to be rotatable along the circumferential direction with respect to the case during assembly.

According to the present invention, it is possible to obtain a rotary drive device and a manufacturing method thereof can be obtained, which make it possible to easily perform phase matching between a rotor and an input shaft or the like.

### BRIEF DESCRIPTION OF THE DRAWINGS

FIG. 1 is a system configuration diagram in which a motor according to an embodiment of the present invention is applied to a drive system.

FIG. 2 is an exploded perspective view of a stator and a rotor included in the motor.

FIG. 3 is an exploded perspective view of the stator and the rotor, an input shaft, and a support member.

FIG. 4 is a longitudinal sectional view of the stator, the rotor, the input shaft, and the support member.

FIG. 5 is an exploded perspective view of a sprocket, the support member, and the input shaft.

FIG. 6 is a plan view showing a relief part between a stator convex part and a case convex part.

FIG. 7 is a partially broken perspective view showing an assembly step using a fixing jig and a phase matching jig.

FIG. 8 is an exploded perspective view showing a disassembled state of the phase matching jig shown in FIG. 6.

FIG. 9 is a longitudinal sectional view showing an assembled state of the phase matching jig.

FIG. 10 is a perspective view of a relative positioning pin.

FIG. 11 is a flowchart showing steps of assembling the stator and the rotor to the case using the fixing jig and the phase matching jig.

### DETAILED DESCRIPTION OF THE EMBODIMENTS

Embodiments of the present invention will be hereinafter described in detail with reference to the accompanying drawings.

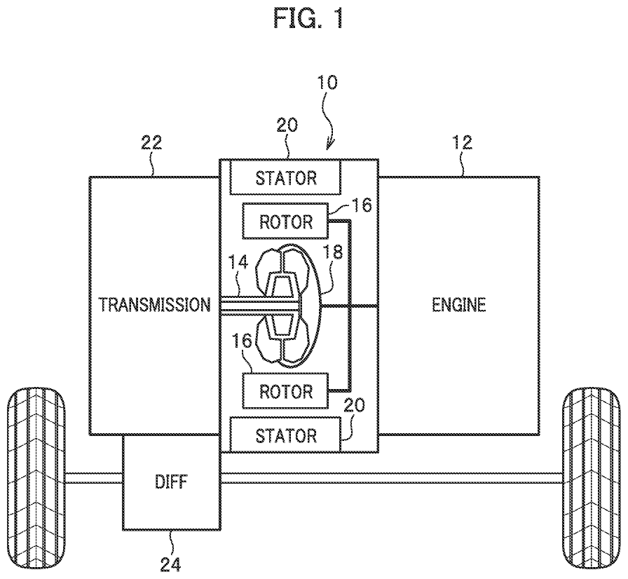

As shown in FIG. 1, a drive system to which a motor (rotary drive device) 10 according to an embodiment of the present invention is applied includes: an engine 12; an input shaft (rotary driving force transmission member) 14 to which rotary driving force is transmitted from the engine 12; a rotor 16 connected to the input shaft 14; a torque converter 18 housed inside the rotor 16; a stator 20 mounted on the outer diameter side of the rotor 16; a transmission 22 arranged on the side opposite to the engine 12 and connected to the input shaft 14; and a differential mechanism (DIFF shown in FIG. 1) 24 connected to the transmission 22.

In this embodiment, description is given taking as an example a case where the torque converter 18 is arranged inside the rotor 16 as a “rotor member”. However, the present invention is not limited thereto, but the rotor may also be used as an individual unit with no torque converter 18 arranged therein, for example.

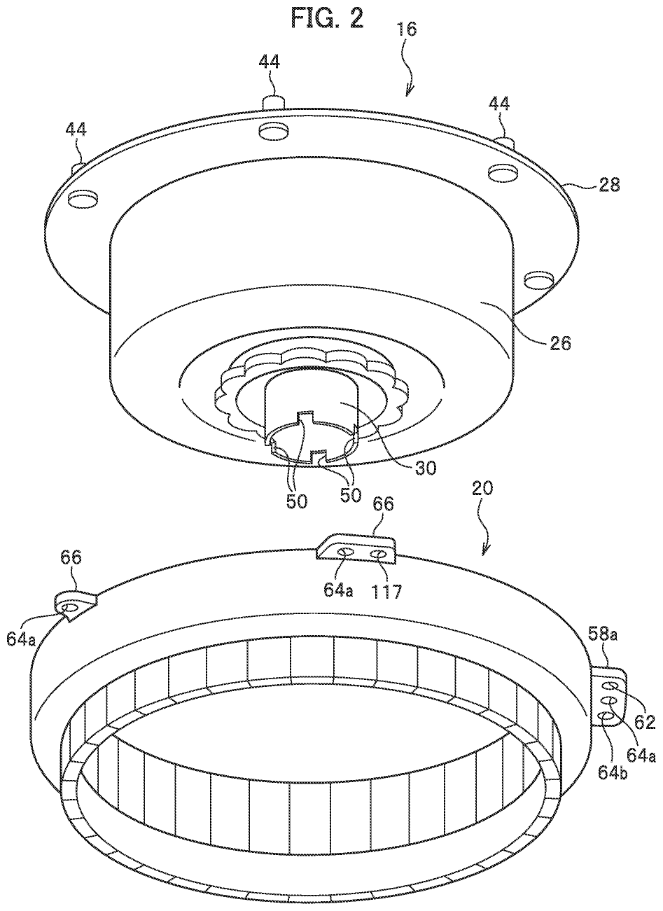

As shown in FIG. 2, the rotor 16 includes a rotor main body 26 formed of a bottomed cylinder, an annular flange 28 protruding radially outward from an upper end of the rotor main body 26, and a cylindrical extension part 30 extending downward from the lower center of the rotor main body 26.

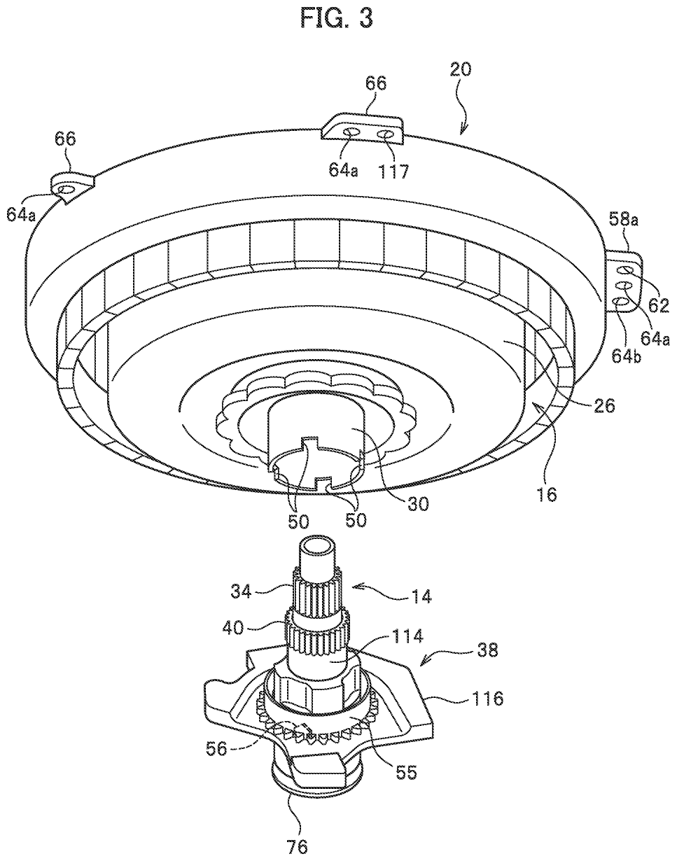

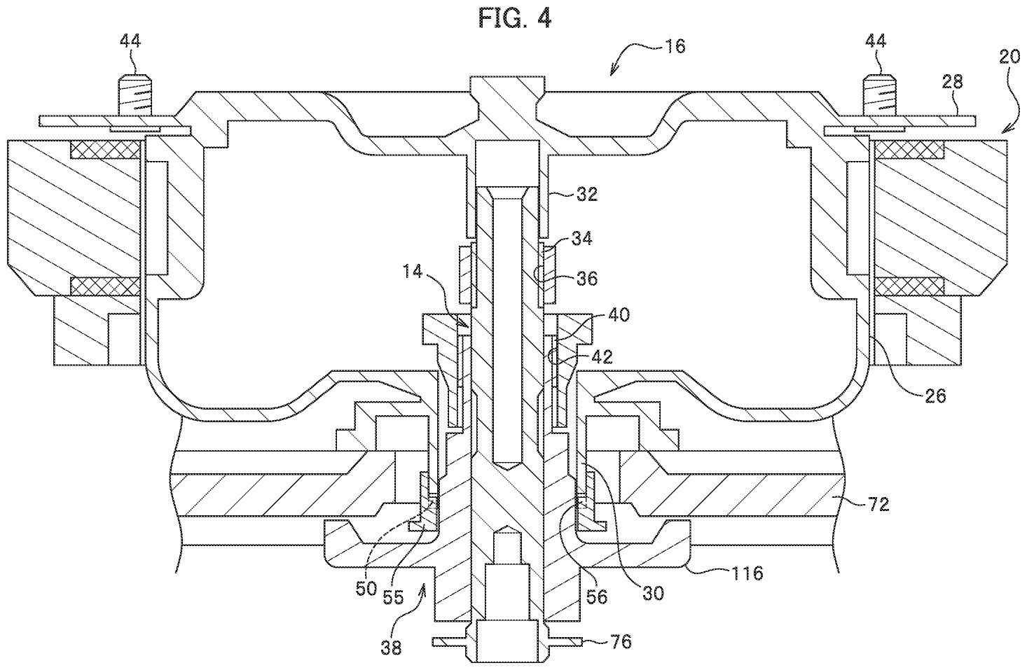

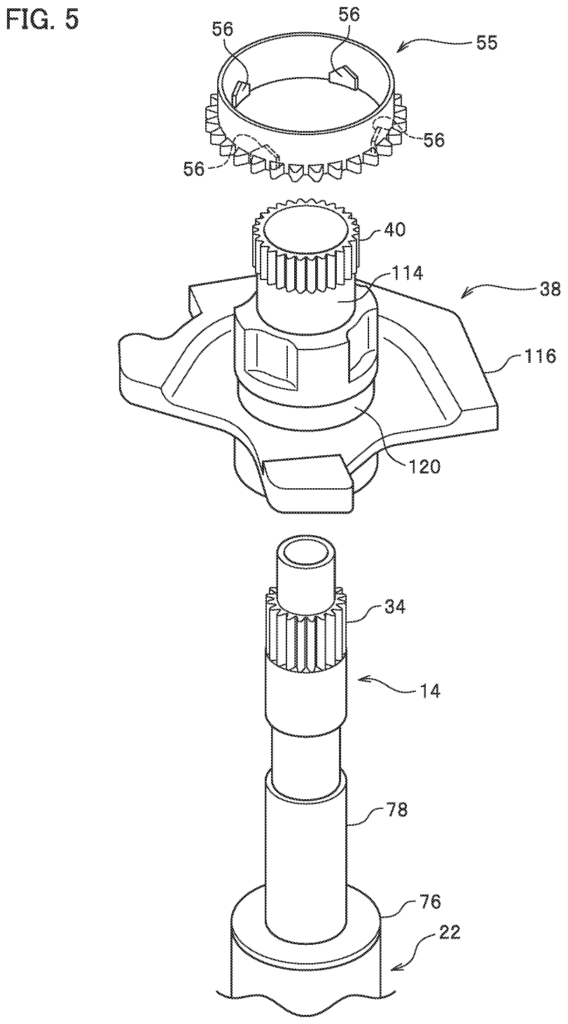

As shown in FIG. 4, the inside of the rotor main body 26 is provided with a cylindrical insertion part 32 that protrudes downward from the inner ceiling surface and into which the tip of the input shaft 14 is inserted. Below the insertion part 32, a spline groove part 36 having a spline groove formed therein that is spline-fitted with a spline part 34 (spline teeth, see FIGS. 3 and 5) provided on the input shaft 14 and a spline groove part 42 having a spline groove formed therein that is spline-fitted with a spline part 40 (spline teeth, see FIGS. 3 and 5) provided on a support member 38 that supports the input shaft 14 are arranged respectively.

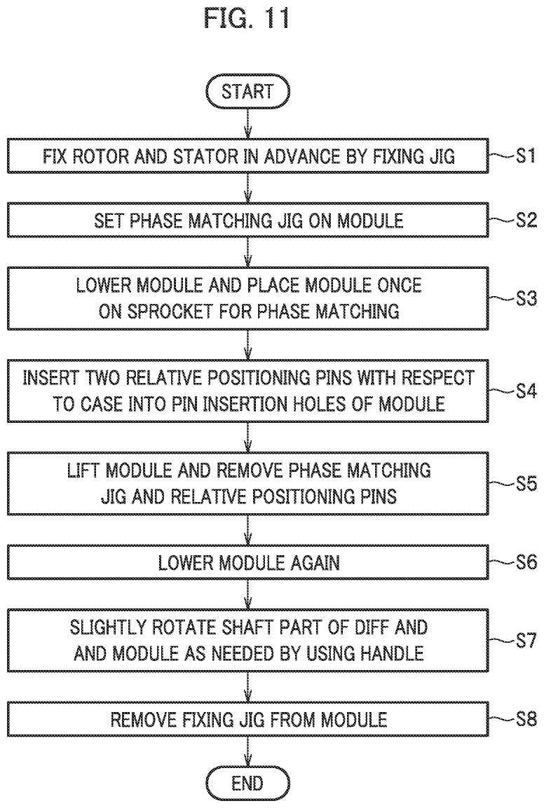

A spline fitting part between the spline groove part 36 and the spline part 34 provided on the input shaft 14 and a spline fitting part between the spline groove part 42 and the spline part 40 provided on the support member 38 that supports the input shaft 14 are out of phase with each other in accordance with the number of spline teeth. Therefore, in this embodiment, as will be described later, phase matching between the two is performed by a rotation operation in step S7 shown in FIG. 11.

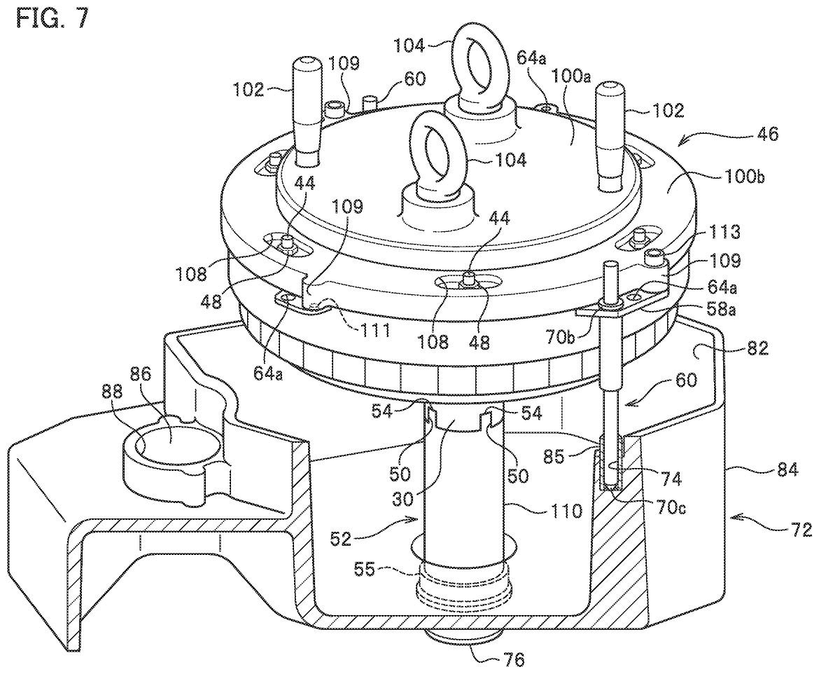

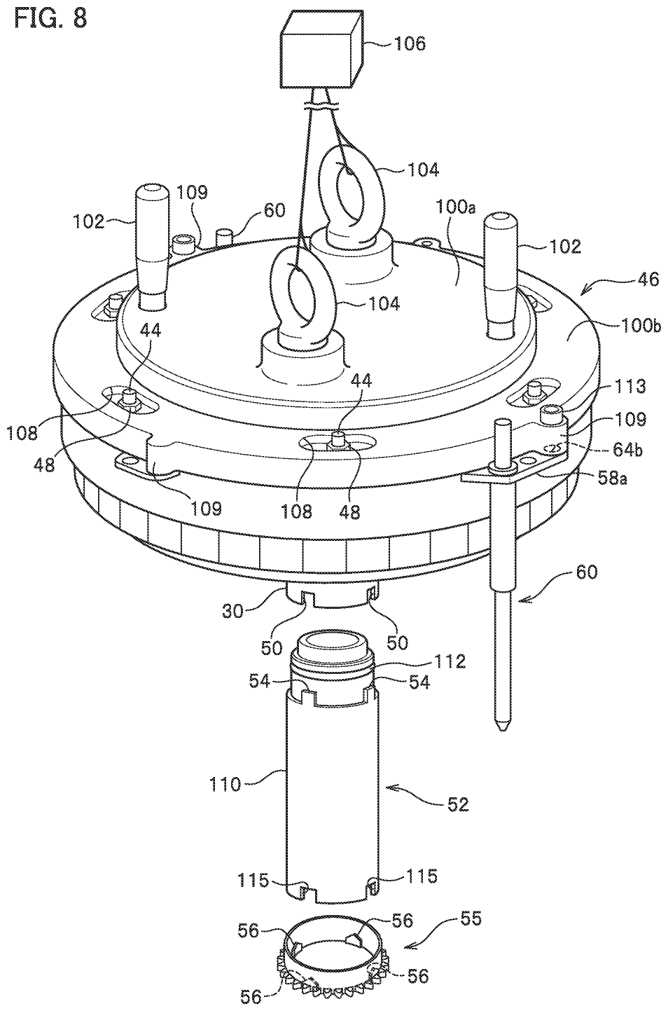

As shown in FIGS. 2 and 3, a plurality of stud bolts 44 are arranged so as to be equiangularly spaced apart in the circumferential direction on the annular flange 28. Each stud bolt 44 is provided so that its threaded part projects upward from the upper surface of the annular flange 28. Each stud bolt 44 is fastened to a nut 48 of a fixing jig 46 to be described later (see FIGS. 7 and 8).

As shown in FIG. 2, at the lower end of the cylindrical extension part 30, four positioning notches 50 are provided, which are arranged so as to be equiangularly spaced apart along the circumferential direction. Each positioning notch 50 has a substantially rectangular shape when viewed from the side. The positioning notch 50 is provided so that an inner diameter protrusion 56 of a sprocket 55 held by the support member 38 that supports the input shaft 14 is mounted (see FIG. 3). The positioning notch 50 is also provided so that a positioning convex part 54 of the phase matching jig 52, which will be described later, is mounted during assembly of the motor 10 (see FIGS. 7 and 8).

The stator 20 is formed of an annular body to which the rotor 16 is fitted, and includes a stator core and a stator winding (not shown).

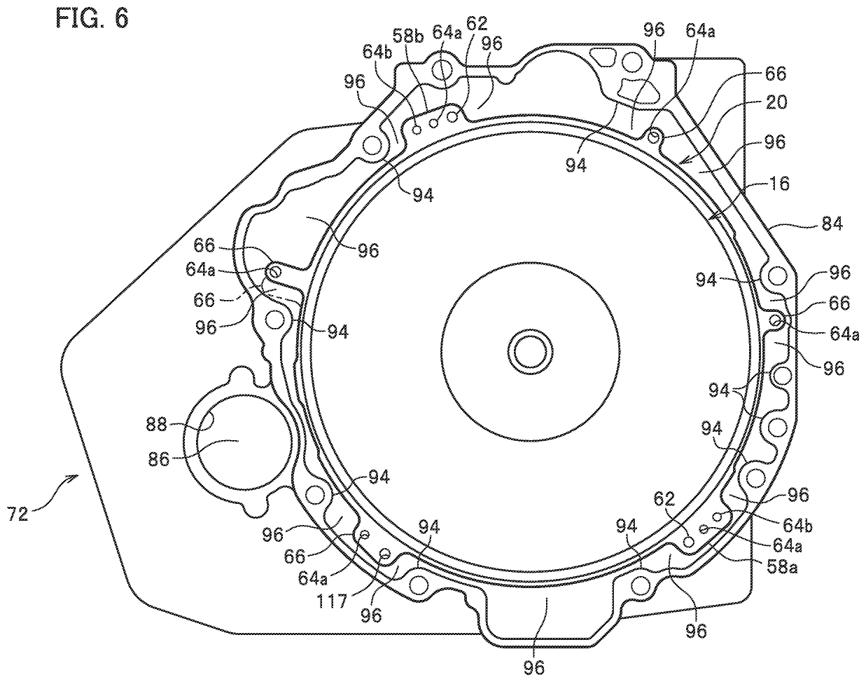

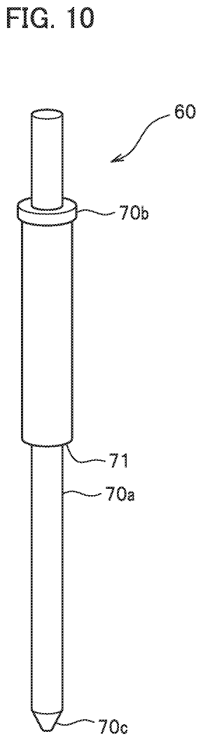

On the outer periphery of the stator 20, a pair of taps 58a and 58b are provided, which are arranged at positions opposite to each other in a substantially diametrical direction (see FIG. 6) and are formed of projecting pieces that protrude radially outward. One tap 58a and the other tap 58b are arranged in mirror symmetry along the outer periphery of the stator 20 (see FIG. 6). Each tap 58a (58b) has a chamfered rectangular shape in plan view and is continuous with the outer peripheral surface of the stator 20 (see FIG. 6). As shown in FIG. 6, in the taps 58a and 58b, a pin insertion hole (knock hole) 62 for inserting a relative positioning pin 60 (see FIG. 10) to be described later and inserting the tip thereof into a knock pin 85, a tightening hole 64a for fastening the stator 20 to a case 72, the fixing jig 46 and the stator 20 via the tightening hole 64a for fastening the stator 20 to the case 72, and a tightening tap hole 64b for fastening the fixing jig 46 and the stator 20 via a tightening bolt 113 (see FIGS. 7 and 8) to be described later are arranged along a counterclockwise direction, respectively. A plurality of tightening holes 64a are arranged along the outer peripheral edge of the stator 20 (see FIG. 6).

As shown in FIG. 6, a plurality of stator convex parts 66 are provided on the outer periphery of the stator 20 so as to extend radially outward and position the stator 20 with respect to the case 72 to be described later. Each of the stator convex parts 66 is provided with the tightening hole 64a for fastening the stator 20 to the case 72 (see FIG. 6).

s shown in FIG. 5, the input shaft 14 includes a disk-shaped base part 76, a shaft part 78 that protrudes upward from the base part 76, and the spline part 34 having a plurality of spline teeth continuously provided along the circumferential direction on the outer peripheral surface on the upper side of the shaft part 78. The base part 76 has its lower surface connected to the transmission 22 (see FIG. 1) (see FIG. 5).

As shown in FIG. 7, the case 72 to which the rotor 16 and the stator 20 are assembled has a case main body 84 having a substantially circular opening 82 and a circular hole 88 in which a shaft part 86 of the differential mechanism 24 is exposed to the outside. The cylindrical knock pin 85 is mounted on a side wall of the case main body 84 via a recess. The knock pin 85 is provided with a knock pin mounting hole 74 in its inner diameter part, into which a tapered part 70c of the relative positioning pin 90 is fitted. The knock pin mounting holes 74 are arranged at positions corresponding to the pair of taps 58a and 58b in the vertical direction, respectively. In other words, when the relative positioning pin 60 inserted through the pair of taps 58a and 58b is inserted into the knock pin mounting hole 74 of the knock pin 85, the phases of the stator 20 and the case 72 match.

As shown in FIG. 6, the case main body 84 is provided with a plurality of case convex parts 94 that extend radially inward from the inner circumference of the side wall and are arranged so as to overlap with the stator convex parts 66 in the circumferential direction. The case convex part 94 is provided so as to bulge in an arc shape toward the outer peripheral side of the stator 20 in plan view.

A relief part 96 is provided between the stator convex part 66 and the case convex part 94 so that the stator convex part 66 can rotate along the circumferential direction with respect to the case 72 during assembly. The relief part 96 is formed of a separation space (space part) along the circumferential direction between the stator convex part 66 and the case convex part 94 arranged so as to overlap with each other in the circumferential direction.

As shown in FIGS. 3 to 5, the support member 38 that rotatably supports the input shaft 14 includes: a cylindrical support part 114 having a through-hole into which the input shaft 14 is inserted; a flat plate-shaped support part 116 that protrudes radially outward from the lower end of the cylindrical support part 114; the spline part 40 that is provided at the upper end of the cylindrical support part 114 and provided with a plurality of spline teeth along the circumferential direction; and an annular part 120 provided at the base of the cylindrical support part 114 close to the flat plate-shaped support part 116.

A substantially ring-shaped sprocket 55 is inserted into the annular part 120. Inside the sprocket 55, four inner diameter protrusions 56 are provided, which are arranged so as to be equiangularly spaced apart along the circumferential direction (see FIG. 5). When a phase matching jig 52 is attached to the inner diameter protrusion 56, a positioning notch 115 provided at the lower end of the cylindrical body 110 is attached and positioned (see FIG. 8).

Next, structures of various jigs used when assembling the rotor 16 and the stator 20 to the case 72 will be described in detail below.

First, the fixing jig 46 for integrally fixing the rotor 16 and the stator 20 will be described. In this embodiment, the rotor 16, the stator 20, and the fixing jig 46, which are integrally fixed, are hereinafter referred to as a “module”.

As shown in FIGS. 7 and 8, in the fixing jig 46, a small-diameter upper disk part 100a provided on the upper side and a large-diameter lower disk part 100b provided on the lower side are coaxially and integrally configured. An annular step part is provided between the outer peripheral surfaces of the upper and lower disk parts 100a and 100b. On the outer peripheral side of the upper surface of the upper disk part 100a, a pair of handles 102 are mounted so as to face each other in the radial direction.

pair of rings 104 are fixed in a direction perpendicular to the diagonal line connecting the pair of handles 102. A wire for performing hoisting and lowering operations by a hoist 106 (including a mechanical hoist, an electric hoist, and the like), for example, is attached to the rings 104 (see FIG. 8). It is preferable that the hoist 106 is provided with a weightless balancer that allows efficient execution of the lifting and lowering operations and reduces frictional force when performing phase matching to be described later.

On the upper surface of the lower disk part 100b, a plurality of fastening recesses 108 having an oval shape in plan view are arranged so as to be spaced apart along the circumferential direction. The nut 48 to be fastened to the stud bolt 44 arranged on the outer peripheral surface of the rotor 16 is fixed inside the fastening recess 108.

On the outer periphery of the lower disk part 100b, a plurality of protrusions 109 (for example, four in this embodiment) are provided so as to project radially outward and to be equiangularly spaced apart along the circumferential direction. Below each projection 109, a jig knock 111 projecting toward the stator 20 side is provided (see the virtual line in FIG. 7). The jig knock 111 is mounted in a jig knock mounting hole 117 (see FIG. 6) of the tap 115 that protrudes radially outward from the outer periphery of the stator 20.

The differential mechanism 24 has the shaft part 86 exposed from a circular hole 88 in the case 72 (see FIG. 6). The shaft part 86 meshes with a plurality of differential gears (not shown), and the input shaft 14 can be rotated in a predetermined direction by rotating the shaft part 86 in a predetermined direction by using a wrench or the like (not shown).

Next, description is given of the phase matching jig 52 that performs phase matching between the phase of the rotor 16 and the stator 20 integrally fixed by the fixing jig 46 and the phase of the case 72.

As shown in FIG. 8, the phase matching jig 52 is formed of a cylindrical body 110 having a through-hole therein along the axial direction. At the lower end of the cylindrical body 110, four positioning notches 115 are provided so as to be equiangularly spaced apart along the circumferential direction, on which the inner diameter protrusions 56 of the sprocket 55 are mounted. An O-ring 112 is mounted on the upper end side of the cylindrical body 110 via an annular groove.

Below the O-ring 112, four positioning convex parts 54 that are equiangularly spaced apart along the circumferential direction are provided on the upper side of the cylindrical body 110. The positioning convex parts 54 are attached to the four positioning notches 50, respectively, that are equiangularly spaced apart by 90 degrees in the circumferential direction at the lower end of the cylindrical extension part 30 extending downward from the rotor 16 (see FIG. 7). The positioning convex part 54 provided on the upper side of the cylindrical body 110 and the positioning notch 115 provided at the lower end are arranged at corresponding positions so as to be located at the same position in the circumferential direction (see FIG. 8).

Two relative positioning pins 60 are used to perform phase matching of the four members including the rotor 16, the stator 20, the case 72, and the sprocket 55. As shown in FIG. 10, the relative positioning pin 60 is integrally formed of a pin main body 70a formed of a columnar shaft, a disk-shaped locking part 70b that is disposed on the upper side of the pin main body 70a and protrudes radially outward, and a tapered part 70c provided at the lower end of the pin main body 70a on the opposite side to the locking part 70b. A stepped part 71 having a diameter larger than that of the lower side of the pin main body 70a is provided at the intermediate section of the pin main body 70a (see FIG. 10).

When the locking part 70b is inserted into the knock pin insertion holes 62 of the taps 58a and 58b, the locking part 70b abuts on the taps 58a and 58b and is locked (see FIG. 7). The tapered part 70c is mounted in the knock pin mounting hole 74 of the knock pin 85 fixed to the recess of the case 72 to restrict the insertion of the relative positioning pin 60 into the case 72, and the relative positioning pin 60 is supported by the knock pin mounting hole 74 with desired position accuracy (see FIG. 7).

The drive system to which the motor 10 according to this embodiment is applied is basically configured as described above. Next, a manufacturing method thereof will be described in detail based on a flowchart shown in FIG. 11.

First, the rotor 16 and the stator 20 are fixed in advance with the fixing jig 46 to form a module (step S1). To be more specific, a plurality of stud bolts 44 provided on the annular flange 28 of the rotor 16 are fastened to the nuts 48 fixed in the fastening recesses 108 of the lower disk part 100b of the fixing jig 46.

The bolts 113 inserted into the bolt insertion holes 111 provided in the protrusions 109 of the lower disk part 100b of the fixing jig 46 are fastened to the bolt fastening holes 64 of the taps 58a and 58b that protrude radially outward from the outer periphery of the stator 20. Thus, the three members including the rotor 16, the stator 20, and the fixing jig 46 are integrally fixed to form a module.

Next, as shown in FIG. 8, the phase matching jig 52 is set in the module (step S2). To be more specific, each positioning convex part 54 provided on the upper side of the cylindrical body 110 of the phase matching jig 52 is mounted on each of the positioning notches 50 provided at the lower end of the cylindrical extension part 30 extending downward from the center of the rotor 16.

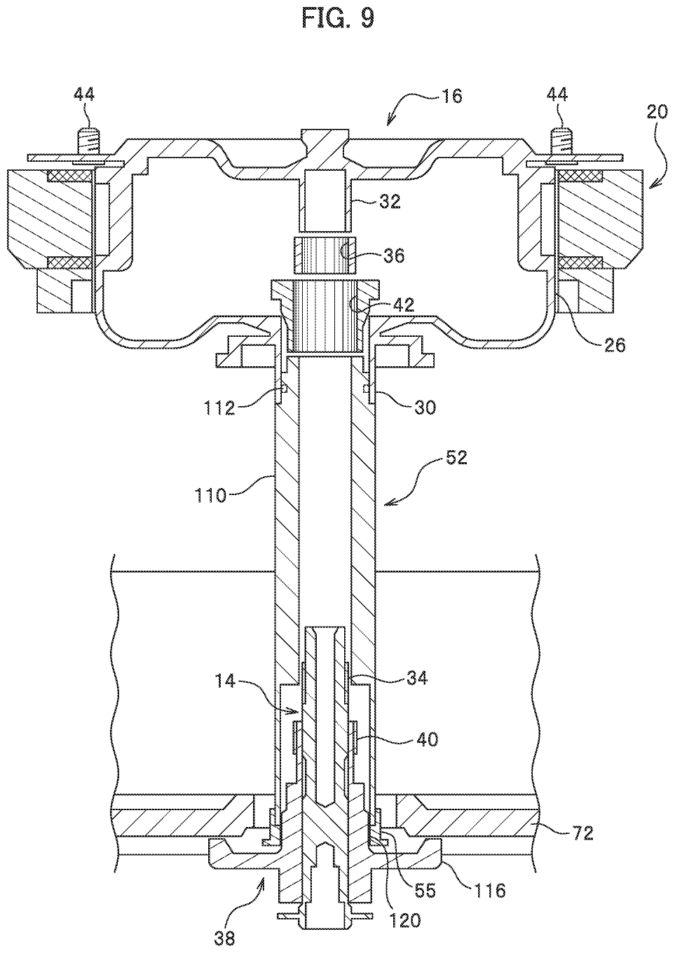

Then, the hoist 106 (see FIG. 8) is operated to lower the module and the phase matching jig 52, which are once placed on the sprocket 55 to match the phases (step S3). In this event, each inner diameter protrusion 56 of the sprocket 55 is mounted on each positioning notch 115 provided at the lower end of the cylindrical body 110 of the phase matching jig 52 (see FIGS. 7 and 9). Thus, the phases of the rotor 16 and the sprocket 55 match.

Thereafter, the relative positioning pins 60 are inserted into the pin insertion holes 62 of the taps 58a and 58b included in the module, and the lower end of each relative positioning pin 60 including the tapered part 70c is inserted into the pin mounting hole 74 of the case 72 (step S4). Thus, the relative positions of the four members including the rotor 16, the stator 20, the case 72, and the sprocket 55 are positioned at predetermined positions.

Subsequently, the hoist 106 is operated to raise the module, and the phase matching jig 52 and the relative positioning pin 60 are removed (step S5). In this event, since the module is only moved up and down, the relative positions of the four members in the rotation direction hardly change. The hoist 196 is operated to lower the module again, and the module is mounted inside the opening 82 of the case 72 (step S6). In this event, the inner diameter protrusion 56 of the sprocket 55 held by the support member 38 that supports the input shaft 14 is mounted on the positioning notch 50 provided in the cylindrical extension part 30 of the rotor 16 (see FIG. 3).

The phase of the spline fitting part between the spline part 34 and the spline groove part 36 provided on the input shaft 14 shown in FIG. 4 is shifted from that of the spline fitting part between the spline part 40 and the spline groove part 42 provided on the support member 38 that supports the input shaft 14 according to the number of teeth of the spline. Therefore, in a state where the module is attached to the case 72, the shaft part 86 of the differential mechanism 24 exposed from the circular hole 88 of the case 72 is slightly rotated by a wrench, for example, and/or the module itself is slightly rotated using the handle 102 of the fixing jig 46, as appropriate (step S7). This rotation operation may be performed in either clockwise direction or counterclockwise direction. As a result, in this embodiment, the shaft part 86 and/or the module itself is rotated to perform phase matching between the spline fitting part between the spline part 34 and the spline groove part 36 provided on the input shaft 14 and the spline fitting part between the spline part 40 and the spline groove part 42 provided on the support member 38 that supports the input shaft 14.

In this embodiment, the relief part 96 is provided between the stator convex part 66 and the case convex part 94 that overlaps with the stator convex part 66 in the circumferential direction. This adjustment of rotation operation allows the module (stator convex part 66) to be rotated with respect to the case 72 by the amount of the separation space of the relief part 96 (see the chain double-dashed line in FIG. 6).

The phase matching of the rotor 16 and the input shaft 14 or the like may be performed by at least one of or both of the rotation operation of the shaft part 86 and the rotation operation of the module itself. Thus, the phase matching of the rotor 16 and the input shaft 14 or the like can be easily and quickly performed.

Finally, after the module is lowered to the assembly complete position by operating the hoist 106, the nuts 48 and the bolts 113 are removed, and the fixing jig 46 is removed from the rotor 16 and the stator 20 to complete the assembly process (step S8).

In this embodiment, the assembly process in steps S1 to S8 facilitates the phase matching of the rotor 16 and the input shaft 14 or the like even when the rotor 16 and the stator 20 are integrally configured by the fixing jig 46.

Although the phase matching jig 52 is set on the module side in step S2 in this embodiment, the phase matching jig 52 may be set on the sprocket 55 side (case 72 side), for example. That is, after setting the phase matching jig 52 on the sprocket 55 provided on the input shaft 14, the hoist 106 is operated to displace the module, and the phase matching jig 52 may be mounted on the module (the cylindrical extension part 30 of the rotor 16) to perform phase matching of the rotor 16 and the sprocket 55. Thus, the phase matching of the rotor 16 and the input shaft 14 or the like can be easily performed.

What is claimed is:

1. A rotary drive device including a rotor member connected to a rotary driving force transmission member, a stator mounted on the radially outer side of the rotor member, and a case that has the rotary driving force transmission member and has the rotor member and the stator assembled therein, and in which the rotor member and the stator are fixed to each other by a fixing jig during assembly to the case, comprising:
a stator convex part that extends radially outward from an outer circumference of the stator and positions the stator with respect to the case; and
a case convex part that extends radially inward from an inner circumference of the case and is arranged so as to overlap with the stator convex part in a circumferential direction, wherein
a relief part is provided between the stator convex part and the case convex part so as to allow the stator convex part to be rotatable along the circumferential direction with respect to the case during assembly.

2. A method for manufacturing a rotary drive device according to claim 1, comprising the steps of:
integrally fixing the rotor member and the stator using the fixing jig to form a module;
setting a phase matching jig with respect to the module;
displacing the module and mounting the phase matching jig on a sprocket provided on the rotary driving force transmission member to perform phase matching of the rotor and the sprocket;
inserting a relative positioning pin with respect to the case into a pin insertion hole of the module to perform phase matching of the rotor member, the stator, the sprocket, and the case;
displacing the module and removing the phase matching jig and the relative positioning pin;
displacing the module and inserting the module into the case;
mounting the rotor member on the sprocket by rotating the module itself with respect to the case via the relief part; and
removing the fixing jig from the module.

3. A method for manufacturing a rotary drive device according to claim 1, comprising the steps of:
integrally fixing the rotor member and the stator using the fixing jig to form a module;
setting a phase matching jig with respect to a sprocket provided on the rotary driving force transmission member;
displacing the module and mounting the phase matching jig on the module to perform phase matching of the rotor and the sprocket;
inserting a relative positioning pin with respect to the case into a pin insertion hole of the module to perform phase matching of the rotor member, the stator, the sprocket, and the case;
displacing the module and removing the phase matching jig and the relative positioning pin;
displacing the module and inserting the module into the case;
mounting the rotor member on the sprocket by rotating the module itself with respect to the case via the relief part; and
removing the fixing jig from the module.
